(19) United States
(12) Patent Application Publication
(10) Pub. No.: US 2026/0160462 A1
(43) Pub. Date: Jun. 11, 2026

(54) REFRIGERATION CYCLE APPARATUS

(71) Applicant: Mitsubishi Electric Corporation, Tokyo (JP)

(72) Inventors: Kosuke MIYAWAKI, Tokyo (JP); Kengo HIRATSUKA, Tokyo (JP); Soshi IKEDA, Tokyo (JP)

(73) Assignee: Mitsubishi Electric Corporation, Tokyo (JP)

(21) Appl. No.: 18/707,177

(22) PCT Filed: Nov. 29, 2021
(86) PCT No.: PCT/JP2021/043598

§ 371 Date: May 3, 2024

(51) Int. Cl. F25B 49/02; F25B 13/00; F25B 41/20

(52) U.S. Cl. CPC F25B 49/022; F25B 13/00; F25B 41/20; F25B 2313/0233; F25B 2313/031; F25B 2600/0253; F25B 2600/2513

(57) ABSTRACT

A refrigeration cycle apparatus includes a compressor, a condenser, a refrigerant-refrigerant heat exchanger provided with a condensed fluid passage and a low-pressure passage, and configured to exchange heat between the working fluid flowing in the condensed fluid passage and the working fluid flowing in the low-pressure passage, a first expansion device configured to reduce a pressure of the working, an evaporator configured to evaporate the working fluid, an optical sensor provided on a pipe connecting between an outlet of the condensed fluid passage and the first expansion device, and provided with an irradiator configured to irradiate the working fluid flowing in the pipe with light and a detector configured to detect a light transmitting through the working fluid, and a controller configured to obtain a concentration of a component included in the working fluid based on a detection result of the optical sensor.

### TECHNICAL FIELD

The present disclosure relates to a refrigeration cycle apparatus, and more particularly to a refrigeration cycle apparatus provided with an optical sensor.

### BACKGROUND ART

In general refrigeration cycle apparatus, refrigerant discharged from a compressor is condensed in a condenser and enters a liquid state. Then, the refrigerant in a liquid state is decompressed by an expansion device and enters a two-phase gas-liquid state in which both the refrigerant in a gas state and the refrigerant in a liquid state are present. Then, the refrigerant in a liquid state out of the refrigerant in a two-phase gas-liquid state is evaporated in an evaporator and the refrigerant in a two-phase gas-liquid state enters a low-pressure gas state. The refrigerant in a low-pressure gas state flowed out of the evaporator is sucked and compressed by the compressor, enters a high-temperature, high-pressure gas state, and is again discharged from the compressor. This cycle is repeated in the refrigeration cycle apparatus.

In a refrigeration cycle apparatus, the refrigerant discharged from a compressor contains excess refrigerating machine oil in some cases. In addition, it is known that, when a zeotropic refrigerant mixture is used as a working fluid in a refrigeration cycle apparatus, the composition ratio of circulating refrigerant changes depending on an operation condition, such as cooling or heating. When the composition ratio of the circulating refrigerant is changed, the saturation temperature of the refrigerant cannot be accurately detected, and consequently excess refrigerant in a liquid state may enter the compressor. In this case, the refrigerating machine oil is diluted and causes seizure in the compressor, causing failure of the compressor.

For this reason, it is important to obtain the concentration of components included in the working fluid, such as the concentration of the refrigerating machine oil in the working fluid or the composition ratio of a refrigerant mixture, in the refrigeration cycle apparatus. As a method of measuring the component concentration of a working fluid, a spectroscopic measurement method using an optical sensor is known (see, for example, Patent Literature 1).

### CITATION LIST

### Patent Literature

Patent Literature 1: Japanese Unexamined Utility Model Registration Application Publication No. 4-095276

### SUMMARY OF INVENTION

### Technical Problem

The refrigeration cycle apparatus of Patent Literature 1 is provided with an optical sensor in the refrigerant pipe arranged between the condenser and the receiver. When a low load operation is performed in such a refrigeration cycle apparatus, the degree of subcooling at the outlet of the condenser is reduced and the refrigerant in a gas state is mixed into the refrigerant flowing in the refrigerant pipe arranged between the condenser and the receiver. Consequently, a gas-liquid interface is formed in the refrigerant pipe. Due to scattering of light caused by the gas-liquid interface or due to the difference in the flow velocity between the liquid phase and the gas phase, the component concentration of the working fluid cannot be accurately obtained in some cases.

The present disclosure has been made to overcome the above-mentioned problem, and has an object to improve accuracy in measuring the component concentration of a working fluid in a refrigeration cycle apparatus.

### Solution to Problem

A refrigeration cycle apparatus according to an embodiment of the present disclosure includes a compressor configured to compress and discharge a working fluid, a condenser configured to condense the working fluid discharged from the compressor, a refrigerant-refrigerant heat exchanger provided with a condensed fluid passage in which the working fluid flowing out of the condenser flows and a low-pressure passage in which the working fluid having a lower pressure than that of the working fluid flowing in the condensed fluid passage flows, and configured to exchange heat between the working fluid flowing in the condensed fluid passage and the working fluid flowing in the low-pressure passage, a first expansion device configured to reduce a pressure of the working fluid flowing out of the condensed fluid passage of the refrigerant-refrigerant heat exchanger, an evaporator configured to evaporate the working fluid, the pressure of which is reduced by the first expansion device, an optical sensor provided on a pipe connecting between an outlet of the condensed fluid passage of the refrigerant-refrigerant heat exchanger and the first expansion device, and provided with an irradiator configured to irradiate the working fluid flowing in the pipe with light and a detector configured to detect a light transmitting through the working fluid, and a controller configured to obtain a concentration of a component included in the working fluid based on a detection result of the optical sensor.

### Advantageous Effects of Invention

According to the refrigeration cycle apparatus according to an embodiment of the present disclosure, because the optical sensor is provided on the pipe connecting between the outlet of the condensed fluid passage in the refrigerant-refrigerant heat exchanger and the first expansion device, the refrigerant flowing in the pipe is always kept in a liquid state, and thus the accuracy in detecting the transmitted light by the optical sensor is improved. As a result, the accuracy in measuring the component concentration of the working fluid is improved.

### BRIEF DESCRIPTION OF DRAWINGS

FIG. 1 is a refrigerant circuit diagram of a refrigeration cycle apparatus according to Embodiment 1.

FIG. 2 is a schematic configuration diagram of an optical sensor according to Embodiment 1.

FIG. 3 is a control block diagram of the refrigeration cycle apparatus according to Embodiment 1.

FIG. 4 is a graph illustrating an example of light absorbance characteristics of two components included in a working fluid.

FIG. 5 is an explanatory diagram about a transmitted light detection for a working fluid in a conventional example.

FIG. 6 is a refrigerant circuit diagram of the refrigeration cycle apparatus according to Embodiment 2.

FIG. 7 is a refrigerant circuit diagram of the refrigeration cycle apparatus according to Embodiment 3.

FIG. 8 is a Mollier diagram for a case where the refrigerant flowing in a refrigerant pipe enters a two-phase gas-liquid state due to pressure loss by a second expansion device.

FIG. 9 is a Mollier diagram for the refrigeration cycle apparatus according to Embodiment 3.

FIG. 10 is a refrigerant circuit diagram of the refrigeration cycle apparatus according to Embodiment 4.

FIG. 11 is an explanatory diagram about flows of the refrigerant in a cooling operation of the refrigeration cycle apparatus according to Embodiment 4.

FIG. 12 is an explanatory diagram about flows of the refrigerant in a heating operation of the refrigeration cycle apparatus according to Embodiment 4.

FIG. 13 is a refrigerant circuit diagram of the refrigeration cycle apparatus according to Embodiment 5.

FIG. 14 is a refrigerant circuit diagram of the refrigeration cycle apparatus according to Modification Example 1.

FIG. 15 is a schematic diagram illustrating an installation direction of the optical sensor of the refrigeration cycle apparatus according to Modification Example 2.

FIG. 16 is an explanatory diagram about a state of the working fluid at a low flow velocity.

FIG. 17 is a schematic diagram illustrating an installation direction of the optical sensor of the refrigeration cycle apparatus according to Modification Example 3.

FIG. 18 is a refrigerant circuit diagram of the refrigeration cycle apparatus according to Modification Example 4.

FIG. 19 is a refrigerant circuit diagram of the refrigeration cycle apparatus according to Modification Example 5.

FIG. 20 is a refrigerant circuit diagram of the refrigeration cycle apparatus according to Modification Example 6.

### DESCRIPTION OF EMBODIMENTS

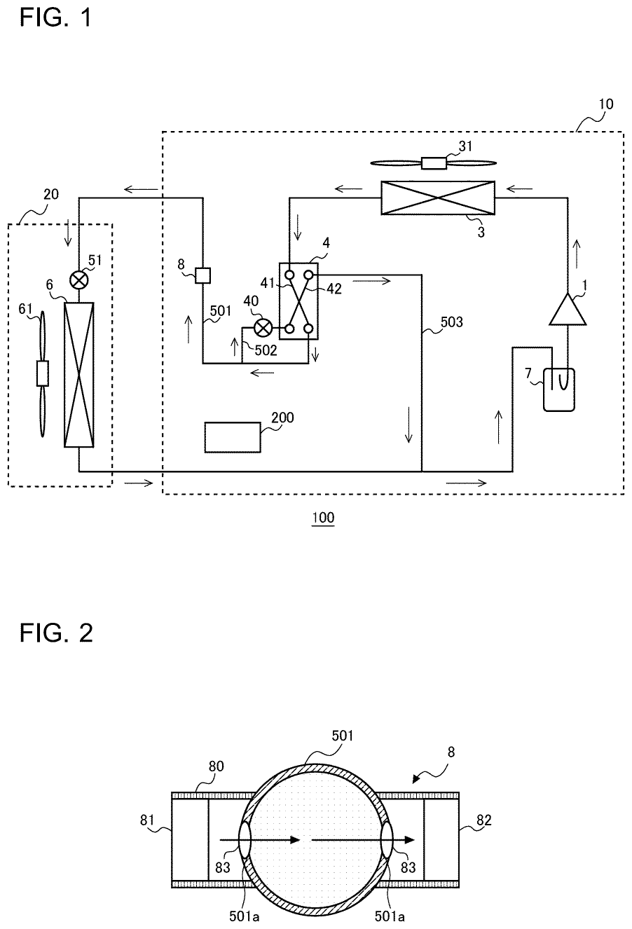

Hereinafter, a refrigeration cycle apparatus according to embodiments of the present disclosure will be described with reference to the drawings. In the drawings below including FIG. 1, components denoted by the same reference symbols are the same or corresponding components, and this applies to the entire descriptions of the embodiments described below. Further, although terms indicating directions (e.g., “top”, “bottom”, “right”, “left”, “front”, and “rear”) are used, as appropriate, to facilitate understanding, these terms are used only for the explanation purpose and do not limit the arrangement and the orientation of a device or a part. Furthermore, modes of component elements represented in the entire description are mere examples, and the component elements are not limited to the modes given in the description.

### Embodiment 1

### <Configuration of Refrigeration Cycle Apparatus>

FIG. 1 is a refrigerant circuit diagram of a refrigeration cycle apparatus 100 according to Embodiment 1. The refrigeration cycle apparatus 100 of Embodiment 1 is a refrigeration apparatus that performs cooling of a warehouse, a showcase, or a refrigerator. As shown in FIG. 1, the refrigeration cycle apparatus 100 includes a heat-source unit 10 and a load unit 20. The heat-source unit 10 and the load unit 20 have respective casings, and are installed at different places, such as outdoors and indoors.

The heat-source unit 10 includes a compressor 1, a condenser 3, a first fan 31, a refrigerant-refrigerant heat exchanger 4, an expansion device 40 for cooling, an optical sensor 8, and a refrigerant tank 7. The load unit 20 includes a first expansion device 51, an evaporator 6, and a second fan 61.

A refrigerant circuit of the refrigeration cycle apparatus 100 is formed by connecting, in this order, the compressor 1, the condenser 3, the refrigerant-refrigerant heat exchanger 4, the first expansion device 51, the evaporator 6, and the refrigerant tank 7 by a pipe. Note that, the refrigerant tank 7 is optional and may be omitted. The refrigerant flowing in the refrigerant circuit is a zeotropic refrigerant mixture in which at least two kinds of refrigerants having different boiling points are mixed. Examples of such refrigerants include a propylene-based refrigerant such as tetrafluoropropene, an ethylene-based refrigerant such as difluoroethylene, an ethane-based refrigerant such as tetrafluoroethane, propane, and dimethyl ether (DME). Note that, examples of an olefin-based refrigerant include HFO1234yf and HFO1234ze(E). In addition, a single refrigerant of, for example, R32, HFO1234yf, HFF1123zf or propane, or a refrigerant mixture in which two or more kinds of those refrigerants are mixed may be used as the refrigerant.

The refrigeration cycle apparatus 100 further includes a controller 200 configured to control an operation state of the refrigeration cycle apparatus 100. Although, in FIG. 1, the heat-source unit 10 includes the controller 200, the load unit 20 may be provided with the controller 200, or the heat-source unit 10 and the load unit 20 may be provided with respective controllers 200 configured to communicate with each other. In addition, the refrigeration cycle apparatus 100 may further include an indoor temperature sensor detecting the temperature of a space to be cooled, an outdoor air temperature sensor detecting the temperature of outside air, and a sensor detecting the temperature or the pressure of the refrigerant flowing in a corresponding heat exchanger. For example, the refrigeration cycle apparatus 100 may include an inlet temperature sensor detecting the temperature of the refrigerant at a refrigerant inlet of the evaporator 6 and an outlet temperature sensor detecting the temperature of the refrigerant at a refrigerant outlet of the evaporator 6.

The compressor 1 is configured to suck the refrigerant, compress the refrigerant into a high-temperature, high-pressure state, and discharge the refrigerant. The refrigerant discharged from the compressor 1 is sent to the condenser 3. The compressor 1 is, for example, a rotary compressor, a scroll compressor, a screw compressor, or a reciprocating compressor. A refrigerating machine oil for lubricating a sliding member is stored in the compressor 1. As the refrigerating machine oil, a substance having good miscibility with the refrigerant and having high stability, such as polyalkylene glycol, polyol ester, polyvinyl ether, alkylbenzene, or a mineral oil, is used.

The condenser 3 is configured to exchange heat between the refrigerant flowing therein and air to condense and liquefy the refrigerant. The condenser 3 is, for example, a fin-and-tube type heat exchanger or a microchannel heat exchanger. To enhance efficiency of the heat exchange between the refrigerant and air in the condenser 3, the first fan 31 is arranged adjacent to the condenser 3. Note that, the condenser 3 may be a heat exchanger that exchanges heat between a heat medium, such as water or brine, and the refrigerant. Examples of such a heat exchanger include a shell-and-tube type heat exchanger, a heat pipe type heat exchanger, a double-pipe type heat exchanger, and a plate type heat exchanger.

The first fan 31 is configured to supply air to the condenser 3. The first fan 31 is a propeller fan, a cross flow fan, or a multiblade centrifugal fan. Note that, when the condenser 3 is configured to exchange heat between a heat medium, instead of air, and the refrigerant, the first fan 31 is omitted but a pump configured to circulate the heat medium is installed instead.

The refrigerant-refrigerant heat exchanger 4 has a condensed fluid passage 41 in which the refrigerant in a high-temperature state flowed out of the condenser 3 flows and a low-pressure passage 42 in which the refrigerant having a pressure and a temperature lower than those of the refrigerant flowing in the condensed fluid passage 41 flows. The refrigerant-refrigerant heat exchanger 4 is configured to exchange heat between the refrigerant flowing in the condensed fluid passage 41 and the refrigerant flowing in the low-pressure passage 42. The refrigerant-refrigerant heat exchanger 4 is a shell-and-tube type heat exchanger, a heat pipe type heat exchanger, a double-pipe type heat exchanger, or a plate type heat exchanger.

The refrigerant-refrigerant heat exchanger 4 is arranged downstream of the condenser 3 in the flow direction of the refrigerant. A refrigerant inlet of the condensed fluid passage 41 in the refrigerant-refrigerant heat exchanger 4 is connected to a refrigerant outlet of the condenser 3. The refrigerant in a high-temperature state flowed out of the condenser 3 flows in the condensed fluid passage 41 of the refrigerant-refrigerant heat exchanger 4. A refrigerant outlet of the condensed fluid passage 41 in the refrigerant-refrigerant heat exchanger 4 is connected to the first expansion device 51 by a refrigerant pipe 501.

In addition, a branch pipe 502 is connected between the refrigerant outlet of the condensed fluid passage 41 and the optical sensor 8. The branch pipe 502 connects the refrigerant pipe 501 and a refrigerant outlet of the low-pressure passage 42 in the refrigerant-refrigerant heat exchanger 4. Part of the refrigerant that was flowed out of the condensed fluid passage 41 of the refrigerant-refrigerant heat exchanger 4 and flows in the refrigerant pipe 501 is routed to the branch pipe 502.

The expansion device 40 for cooling is provided on the branch pipe 502. The expansion device 40 for cooling is configured to expand the refrigerant flowing in the branch pipe 502 to reduce the pressure of the refrigerant, and cause the refrigerant, as refrigerant in a low-temperature state, to enter the low-pressure passage 42 in the refrigerant-refrigerant heat exchanger 4. The expansion device 40 for cooling is, for example, an electronic expansion valve whose opening degree can be controlled.

Note that, the expansion device 40 for cooling is not limited to an electronic expansion valve, and may be a mechanical expansion valve in which a pressure receiving part uses a diaphragm, or may be a capillary tube or a similar device.

A refrigerant outlet of the low-pressure passage 42 is connected to a refrigerant outlet of the evaporator 6 by a refrigerant pipe 503. The refrigerant flowed out from the refrigerant outlet of the low-pressure passage 42 merges with the refrigerant flowed out of the evaporator 6, and enters the refrigerant tank 7.

The first expansion device 51 is configured to expand the refrigerant flowing in the refrigerant pipe 501 to reduce the pressure of the refrigerant. The first expansion device 51 is, for example, an electronic expansion valve whose opening degree can be controlled. Note that, the first expansion device 51 is not limited to an electronic expansion valve, and may be a mechanical expansion valve in which a pressure receiving part uses a diaphragm, or may be a capillary tube or a similar device.

The evaporator 6 is configured to exchange heat between the refrigerant flowing therein and air to evaporate and gasify the refrigerant. The evaporator 6 is, for example, a fin-and-tube type heat exchanger or a microchannel heat exchanger. To enhance efficiency of the heat exchange between the refrigerant and outside air in the evaporator 6, the second fan 61 is arranged adjacent to the evaporator 6. Note that, the evaporator 6 may be a heat exchanger that exchanges heat between a heat medium, such as water or brine, and the refrigerant. Examples of such a heat exchanger include a shell-and-tube type heat exchanger, a heat pipe type heat exchanger, a double-pipe type heat exchanger, and a plate type heat exchanger.

The second fan 61 is configured to supply air to the evaporator 6. The second fan 61 is a propeller fan, a cross flow fan, or a multiblade centrifugal fan. Note that, when the evaporator 6 is configured to exchange heat between a heat medium, instead of air, and the refrigerant, the second fan 61 is omitted but a pump configured to circulate the heat medium is installed instead.

The refrigerant tank 7 is provided between the refrigerant outlet of the evaporator 6 and a suction port of the compressor 1. The refrigerant tank 7 has a refrigerant storage function and a gas-liquid separation function. The refrigerant storage function is a function for storing excess refrigerant. The gas-liquid separation function is a function for separating the refrigerant in a two-phase gas-liquid state flowing into the refrigerant tank 7 from the evaporator 6, discharging the refrigerant in a gas state to the compressor 1, and retaining the refrigerant in a liquid state. The refrigerant tank 7 is, for example, a displacement tank having an inside diameter larger than the inside diameter of a suction pipe connected to the suction port of the compressor 1, or an accumulator. In the refrigeration cycle apparatus 100, the gas-liquid separation function of the refrigerant tank 7 can prevent the compressor 1 from compressing liquid.

The optical sensor 8 is provided on the refrigerant pipe 501 connecting between the refrigerant-refrigerant heat exchanger 4 and the first expansion device 51. The optical sensor 8 is configured to irradiate a working fluid flowing in the refrigerant pipe 501 with light and detect the intensity of the light transmitting through the working fluid. Note that, the “working fluid” in this description corresponds to the refrigerant flowing in the refrigerant circuit, or the refrigerant flowing in the refrigerant circuit and the refrigerating machine oil included in the refrigerant.

FIG. 2 is a schematic configuration diagram of the optical sensor 8 according to Embodiment 1. FIG. 2 schematically shows a cross section of the refrigerant pipe 501 obtained by cutting in the radial direction with the optical sensor 8 being attached to the refrigerant pipe 501. As shown in FIG. 2, the optical sensor 8 includes a casing 80 attached to the refrigerant pipe 501, and an irradiator 81 and a detector 82 provided in the casing 80. The irradiator 81 and the detector 82 are arranged to face each other across the refrigerant pipe 501. In addition, the irradiator 81 has a light source that emits light having a specific wavelength, such as a light-emitting diode (LED), and is configured to emit light based on an instruction of the controller 200. The detector 82 is configured to detect the light emitted from the irradiator 81, convert the intensity of the detected light into an electrical signal, and transmit the signal to the controller 200.

The refrigerant pipe 501 is provided with openings 501a each at a position that faces the irradiator 81 and a position that faces the detector 82. Each of the openings 501a is closed by a window plate 83 of the optical sensor 8. The window plates 83 are made of a material that has transmissivity to the irradiated light and can ensure pressure resistance to the pressure of the working fluid in an operation range of the refrigeration cycle apparatus 100. Before the refrigerant is charged in the refrigerant pipe 501, the light emitted from the irradiator 81 is transmitted to the detector 82 through the refrigerant pipe 501 via the window plates 83.

The controller 200 is configured to control the entire operation of the refrigeration cycle apparatus 100. The controller 200 is formed as a computer provided with a memory storing data and a program necessary for control and a central processing unit (CPU) that executes the program, as dedicated hardware, such as an application specific integrated circuit (ASIC) or a field-programmable gate array (FPGA), or as both.

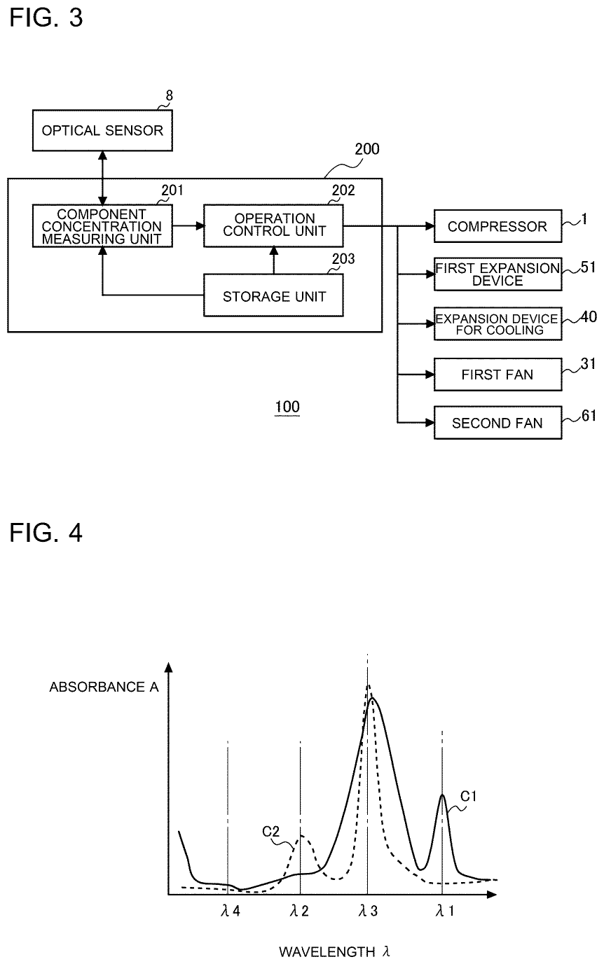

FIG. 3 is a control block diagram of the refrigeration cycle apparatus 100 according to Embodiment 1. As shown in FIG. 3, the controller 200 includes a component concentration measuring unit 201, an operation control unit 202, and a storage 203.

The component concentration measuring unit 201 is a functional unit implemented by executing a program by the CPU of the controller 200 or a functional unit implemented by a dedicated processing circuit. The component concentration measuring unit 201 is configured to control the irradiator 81 of the optical sensor 8 to emit light having a specific wavelength. In addition, the component concentration measuring unit 201 is configured to obtain the concentration of a component included in the working fluid of the refrigeration cycle apparatus 100 based on a detection result of the detector 82 of the optical sensor 8. The concentration of a component included in the working fluid is, for example, the concentration of the refrigerating machine oil included in the refrigerant or the concentration of each refrigerant included in the zeotropic refrigerant mixture. The component concentration measuring unit 201 is configured to transmit the obtained component concentration to the operation control unit 202. Measurement of a component concentration of the working fluid by the component concentration measuring unit 201 is described in more detail later.

The operation control unit 202 is a functional unit implemented by executing a program by the CPU of the controller 200 or a functional unit implemented by a dedicated processing circuit. The operation control unit 202 is configured to control each unit of the refrigeration cycle apparatus 100 based on setting information input via a remote controller (not shown) or a similar device and detection results of various sensors, such as the indoor temperature sensor or the outdoor air temperature sensor. More specifically, the operation control unit 202 is configured to control the operation frequency of the compressor 1, the opening degrees of the first expansion device 51 and the expansion device 40 for cooling, and the rotation speeds of the first fan 31 and the second fan 61 based on setting information and detection results of temperature sensors.

In addition, the operation control unit 202 of Embodiment 1 is configured to control the operation of the refrigeration cycle apparatus 100 in accordance with the component concentration of the working fluid measured by the component concentration measuring unit 201. In general, when the refrigerant in a liquid state is sucked into the compressor 1 during operation of the refrigeration cycle apparatus 100, liquid compression or dilution of the refrigerating machine oil occurs in the compressor 1, causing failure of the compressor 1. For this reason, the operation control unit 202 is configured to, when, for example, the concentration of the refrigerating machine oil in the working fluid is equal to or higher than a predetermined threshold, lower the operation frequency of the compressor 1 or reduce the opening degree of the first expansion device 51 to prevent depletion of the refrigerating machine oil in the compressor 1. As a result, the quality of the refrigerant flowing out of the evaporator 6 is increased and the inflow of the refrigerant in a liquid state into the compressor 1 is prevented.

Furthermore, the operation control unit 202 is configured to, when a zeotropic refrigerant mixture is used as the working fluid in the refrigeration cycle apparatus 100, calculate the composition ratio of the circulating refrigerant mixture from the concentrations of the refrigerants included in the zeotropic refrigerant mixture measured by the component concentration measuring unit 201, and calculate an evaporating saturation temperature from the composition ratio of the circulating refrigerant. In addition, the operation control unit 202 is configured to, when the temperature of the refrigerant flowing out of the evaporator 6 is equal to or lower than the evaporating saturation temperature, lower the frequency of the compressor 1 or reduce the opening degree of the first expansion device 51. As a result, the quality of the refrigerant flowing out of the evaporator 6 is increased and the inflow of the refrigerant in a liquid state into the compressor 1 is prevented.

Moreover, the difference between a liquid saturation temperature and a gas saturation temperature changes depending on the composition ratio of the zeotropic refrigerant mixture. For this reason, the operation control unit 202 may be configured to change the frequency of the compressor 1 and the opening degree of the first expansion device 51 in accordance with the composition ratio of the circulating refrigerant to increase the temperature of the refrigerant at the refrigerant inlet of the evaporator 6. As a result, frost formation and freezing of the evaporator 6 due to lowering of temperature can be prevented.

The storage unit 203 is a volatile or non-volatile memory, such as a random access memory (RAM) or a read-only memory (ROM). The storage unit 203 is configured to store programs for implementing the functions of the component concentration measuring unit 201 and the operation control unit 202, and various data to be used to control each unit, such as parameters and thresholds.

### <Operation of Refrigeration Cycle Apparatus>

Next, returning to FIG. 1, the operation of the refrigeration cycle apparatus 100 will be described along with the flow of the refrigerant. The solid lines in FIG. 1 indicate the flow of the refrigerant. When the compressor 1 of the refrigeration cycle apparatus 100 is driven, the refrigerant in a high-temperature, high-pressure gas state is discharged from the compressor 1. The refrigerant in a high-temperature, high-pressure gas state discharged from the compressor 1 flows into the condenser 3.

In the condenser 3, heat is exchanged between the refrigerant in a high-temperature, high-pressure gas state flowed into the condenser 3 and the air supplied by the first fan 31. The refrigerant that has undergone heat exchange in the condenser 3 is condensed, and enters a high-temperature, high-pressure liquid state or two-phase gas-liquid state.

The refrigerant in a high-temperature, high-pressure liquid state or two-phase gas-liquid state flowed out of the condenser 3 flows into the condensed fluid passage 41 of the refrigerant-refrigerant heat exchanger 4. The refrigerant flowing in the condensed fluid passage 41 of the refrigerant-refrigerant heat exchanger 4 exchanges heat with the refrigerant flowing in the low-pressure passage 42 of the refrigerant-refrigerant heat exchanger 4, and is thus cooled and enters a liquid state. The refrigerant in a liquid state flows out of the condensed fluid passage 41 of the refrigerant-refrigerant heat exchanger 4.

The refrigerant in a liquid state flowed out of the condensed fluid passage 41 of the refrigerant-refrigerant heat exchanger 4 flows in the refrigerant pipe 501, and part of the refrigerant is routed to the branch pipe 502. The refrigerant in a liquid state flowing in the refrigerant pipe 501 passes through the optical sensor 8. The refrigerant in a liquid state passed through the optical sensor 8 is decompressed by the first expansion device 51, enters a low-pressure, two-phase gas-liquid state, and then flows into the evaporator 6.

In the evaporator 6, heat is exchanged between the refrigerant in a two-phase gas-liquid state flowed into the evaporator 6 and the air supplied by the second fan 61, and the refrigerant in a liquid state, out of the refrigerant in a two-phase gas-liquid state, is evaporated and the refrigerant in a two-phase gas-liquid state enters a low-pressure gas state. The air cooled by this heat exchange process is supplied to the space to be cooled, and thus the space is cooled.

Meanwhile, the refrigerant divided to flow in the branch pipe 502 is decompressed by the expansion device 40 for cooling, enters a medium-pressure liquid state or two-phase gas-liquid state having mainly a liquid form, and flows into the low-pressure passage 42 of the refrigerant-refrigerant heat exchanger 4. The refrigerant flowing in the low-pressure passage 42 of the refrigerant-refrigerant heat exchanger 4 exchanges heat with the refrigerant flowing in the condensed fluid passage 41, enters a two-phase gas-liquid state or a low-pressure gas state, and flows out of the low-pressure passage 42 of the refrigerant-refrigerant heat exchanger 4. The refrigerant in a low pressure, two-phase gas-liquid state or gas state flowed out of the low-pressure passage 42 of the refrigerant-refrigerant heat exchanger 4 flows in the refrigerant pipe 503, and merges with the refrigerant in a low-pressure gas state flowed out of the evaporator 6.

The refrigerant in a low-pressure gas state flowed out of the evaporator 6 merges with the refrigerant flowing out of the low-pressure passage 42 of the refrigerant-refrigerant heat exchanger 4, and then flows into the refrigerant tank 7. Then, the refrigerant in a gas state separated in the refrigerant tank 7 is sucked into the compressor 1, compressed again in the compressor 1, and discharged from the compressor 1. This cycle is repeated in the refrigeration cycle apparatus 100.

Next, a method for measuring the component concentration of the working fluid in the refrigeration cycle apparatus 100 of Embodiment 1 will be described. First, the irradiator 81 of the optical sensor 8 emits light having a wavelength designed for components included in the working fluid, based on an instruction from the component concentration measuring unit 201 of the controller 200. The components included in the working fluid is the refrigerant and the refrigerating machine oil. The light emitted by the irradiator 81 is applied to the working fluid flowing in the refrigerant pipe 501. The working fluid absorbs light in accordance with the wavelength sensitivity of absorbance that differs for each component. The remaining light penetrates the window plate 83 and is detected by the detector 82. The detector 82 detects the intensity of the transmitted light for each wavelength and transmits the intensities of the transmitted light to the controller 200.

The component concentration measuring unit 201 of the controller 200 obtains a transmittance T from the intensity of light irradiated from the irradiator 81 and the intensity of the transmitted light detected by the detector 82 to obtain the concentration of a component included in the working fluid. For example, the component concentration measuring unit 201 obtains the concentration of the refrigerating machine oil from the transmittance T at a wavelength according to the type of oil, in the ultraviolet range of 380 nm or less in which the refrigerating machine oil has an absorption peak. As another example, the component concentration measuring unit 201 obtains the concentration of the refrigerant from the transmittance T at a wavelength according to the type of refrigerant, in the infrared region of 780 nm or above in which an olefin-based refrigerant, an ethylene-based refrigerant, or an ethane-based refrigerant has an absorption peak.

To be more specific, the component concentration measuring unit 201 obtains the component concentration by using the Beer-Lambert law shown in Equation (1) below.

$$[ Equation 1 ]$$

$$A ( {λ}_{i} ) = - log ( T ) = ε ( {λ}_{i} ) cl \qquad ( 1 )$$

In Equation 1, T is the transmittance, A is the absorbance, ε (λᵢ) is the absorptivity specific to the component, c is the concentration, and l is the optical path length through the working fluid. In the case of Embodiment 1, l is the diameter of the refrigerant pipe 501. Because the transmittance T, the absorptivity ε (λᵢ) specific to the component, and the optical path length l are known, the concentration c can be obtained from Equation 1.

FIG. 4 is a graph illustrating an example of light absorbance characteristics of two components included in the working fluid. In FIG. 4, the solid line represents the light absorbance characteristic of a first component C1 and the broken line represents the light absorbance characteristic of a second component C2. The first component C1 and the second component C2 are components included in the working fluid, and are, for example, a refrigerant and a refrigerating machine oil, or two refrigerants included in a refrigerant mixture. The component concentration measuring unit 201 is configured to set, as a wavelength of the light to be emitted by the irradiator 81, a first wavelength λ1, which is the absorption wavelength of the first component C1 but not that of the second component C2, and a second wavelength λ2, which is the absorption wavelength of the second component C2 but not that of the first component C1, without using a third wavelength λ3, which is the absorption wavelength of both of the first component C1 and the second component C2. By setting measurement light in this way, the optical sensor 8 can accurately measure the transmitted light for each component.

In addition, by emitting, as a reference light, light having a fourth wavelength \4 that both of the first component C1 and the second component C2 do not absorb from the irradiator 81, the influence of reduction in the light intensity of a detected light due to a cause other than the absorption by a component included in the working fluid, on the measurement can be reduced.

To be more specific, the component concentration measuring unit 201 may be configured to calculate the component concentration of the working fluid by Equation 2 below by using a transmittance T0 of the reference light and a transmittance Ti of the measured light.

$$[ Equation 2 ]$$

$$A ( {λ}_{i} ) = - log ( {T}_{i} / {T}_{0} ) = ε ( {λ}_{i} ) {c}_{i} l \qquad ( 2 )$$

In addition, the component concentration measuring unit 201 is configured to, when the measured light has absorption wavelengths of multiple components, be capable of calculating the component concentration from the multiple wavelengths by Equation 3 below.

$$[ Equation 3 ]$$

$$A ( {λ}_{i} ) = - log ( {T}_{i} / {T}_{0} ) = \sum ε ( {λ}_{i} ) {c}_{i} l \qquad ( 3 )$$

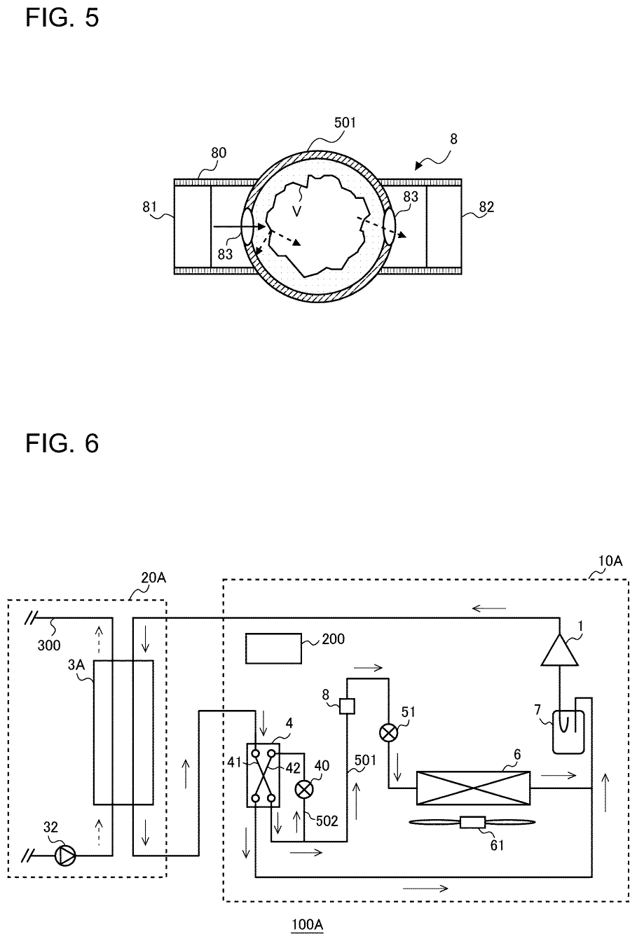

FIG. 5 is an explanatory diagram about a transmitted light detection for a working fluid in a conventional example. The conventional example of FIG. 5 shows a case where the refrigerant-refrigerant heat exchanger 4 is not provided between the condenser 3 and the optical sensor 8 in the refrigeration cycle apparatus 100. In the conventional example, when the refrigeration cycle apparatus 100 performs a low-load operation and the degree of subcooling of the refrigerant at the refrigerant outlet of the condenser 3 is reduced, the refrigerant flowing in the refrigerant pipe 501 on which the optical sensor 8 is provided enters a two-phase gas-liquid state. In this case, as shown in FIG. 5, a gas-liquid interface V is formed in the working fluid in the refrigerant pipe 501. The irradiating light of the optical sensor 8 is reflected and refracted on the gas-liquid interface V and thus is scattered, and consequently the intensity of the transmitted light detected by the detector 82 is reduced.

Furthermore, the optical measurement using the optical sensor 8 can measure only a volume ratio in the measuring region. A composition ratio can be measured because the composition ratio is substantially equals the volume ratio when the fluid of a single phase liquid flows at a constant speed. For a case of a two-phase liquid, a gas flow velocity and a liquid flow velocity are different, and the composition ratio of the liquid phase is obtained as the ratio of (gas component velocity×gas component volume+liquid component velocity×liquid component volume). In general, it is difficult to measure a gas flow velocity and a liquid flow velocity. Therefore, when the working fluid flowing in the refrigerant pipe 501 is a two-phase fluid, the detection accuracy of the detector 82 is lowered.

On the other hand, in the refrigeration cycle apparatus 100 of Embodiment 1, the refrigerant-refrigerant heat exchanger 4 configured to cause the refrigerant in a high-temperature state flowing out of the condenser 3 to exchange heat with the refrigerant in a low-temperature state and enter a liquid state is provided between the condenser 3 and the optical sensor 8. With this configuration, the working fluid flowing in the refrigerant pipe 501 provided with the optical sensor 8 is certainly kept in a liquid state (single-phase state), and thus a gas-liquid interface V is not formed in the refrigerant pipe 501. As a result, the accuracy in detecting the transmitted light of the working fluid by the optical sensor 8 is improved and thus the accuracy in measuring the component concentration of the working fluid is also improved.

With the improvement in the accuracy in obtaining the component concentration of the working fluid, an operation control in which occurrence of dilution of the refrigerating machine oil in the compressor 1 is reduced to suppress failure and an operation control in which frost formation and freezing are suppressed can be appropriately performed. Note that although the degree of superheat of the refrigerant at the inlet of the compressor 1 can be increased to suppress dilution of the refrigerating machine oil, this approach increases input of the compressor 1 per capacity, and thus it is difficult to satisfy both quality and performance improvement. On the other hand, in Embodiment 1, both quality and performance improvement can be satisfied.

Especially when the refrigerant contains an R32 refrigerant, because the R32 refrigerant has a small gas density at the same saturation temperature, a change in a saturation temperature in a two-phase region is increased and the effect of the operation control is increased.

In addition, in the refrigeration cycle apparatus 100 of Embodiment 1, the optical sensor 8 is provided in the same unit (heat-source unit 10 in Embodiment 1) in which the refrigerant-refrigerant heat exchanger 4 is provided. Therefore, compared with a case where the optical sensor 8 is provided in a unit different from the unit having the refrigerant-refrigerant heat exchanger 4, because the working fluid can be prevented from entering a two-phase gas-liquid state due to pressure loss of the refrigerant pipe 501 connecting between the units, the refrigeration cycle apparatus 100 of Embodiment 1 is more effective.

### Embodiment 2

### <Configuration of Refrigeration Cycle Apparatus>

FIG. 6 is a refrigerant circuit diagram of a refrigeration cycle apparatus 100A according to Embodiment 2. The refrigeration cycle apparatus 100A of Embodiment 2 is a hot water supply apparatus configured to supply hot water or a hot water heating apparatus configured to perform heating using hot water. The solid lines in FIG. 6 indicate the flow of the refrigerant and the broken lines indicate the flow of water. Note that FIG. 6 shows only a part of a water circuit 300 to simplify the illustration.

As shown in FIG. 6, the refrigeration cycle apparatus 100A includes a heat-source unit 10A and a load unit 20A. The heat-source unit 10A and the load unit 20A have respective casings, and are installed at different places, such as outdoors and indoors.

The heat-source unit 10A includes the compressor 1, the refrigerant-refrigerant heat exchanger 4, the expansion device 40 for cooling, the optical sensor 8, the first expansion device 51, the evaporator 6, the second fan 61, the refrigerant tank 7, and the controller 200. The load unit 20A includes a condenser 3A and a pump 32.

The configurations and functions of the compressor 1, the refrigerant-refrigerant heat exchanger 4, the expansion device 40 for cooling, the first expansion device 51, the evaporator 6, the second fan 61, the refrigerant tank 7, the optical sensor 8, and the controller 200 of the heat-source unit 10A are the same as those of Embodiment 1.

The condenser 3A of the load unit 20A is a heat exchanger that exchanges heat between the refrigerant flowing in the refrigerant circuit and water flowing in the water circuit 300. Examples of such a heat exchanger include a shell-and-tube type heat exchanger, a heat pipe type heat exchanger, a double-pipe type heat exchanger, and a plate type heat exchanger.

The pump 32 is configured to circulate water through the water circuit 300. The pump 32 is provided with an inverter circuit (not shown), and is configured to change the flow rate of water to be fed by chancing the driving rotation speed according to an instruction from the controller 200.

### <Operation of Refrigeration Cycle Apparatus>

Next, the operation of the refrigeration cycle apparatus 100A will be described along with the flow of the refrigerant. When the compressor 1 of the refrigeration cycle apparatus 100A is driven, the refrigerant in a high-temperature, high-pressure gas state is discharged from the compressor 1. The refrigerant in a high-temperature, high-pressure gas state discharged from the compressor 1 flows into the condenser 3A.

In the condenser 3A, heat is exchanged between the refrigerant in a high-temperature, high-pressure gas state flowed into the condenser 3A and the water flowing in the water circuit 300. The refrigerant that has undergone heat exchange in the condenser 3A is condensed, and enters a high-pressure liquid state or two-phase gas-liquid state. In addition, the water heated through the heat exchange with the refrigerant in the condenser 3A is used for hot water supply or hot water heating.

The refrigerant in a high-pressure liquid state or two-phase gas-liquid state flowed out of the condenser 3A flows into the condensed fluid passage 41 of the refrigerant-refrigerant heat exchanger 4. The flow of the refrigerant after the refrigerant-refrigerant heat exchanger 4 is the same as that in Embodiment 1.

As described above, also in the refrigeration cycle apparatus 100A of Embodiment 2, the refrigerant-refrigerant heat exchanger 4 configured to cause the refrigerant in a high-temperature state flowed out of the condenser 3A to exchange heat with the refrigerant in a low-temperature state and enter a liquid state is provided between the condenser 3A and the optical sensor 8. With this configuration, because the working fluid flowing in the refrigerant pipe 501 provided with the optical sensor 8 is certainly kept in a liquid state, the accuracy in detecting the transmitted light of the working fluid by the optical sensor 8 is improved and thus the accuracy in measuring the component concentration of the working fluid is improved.

### Embodiment 3

### <Configuration of Refrigeration Cycle Apparatus>

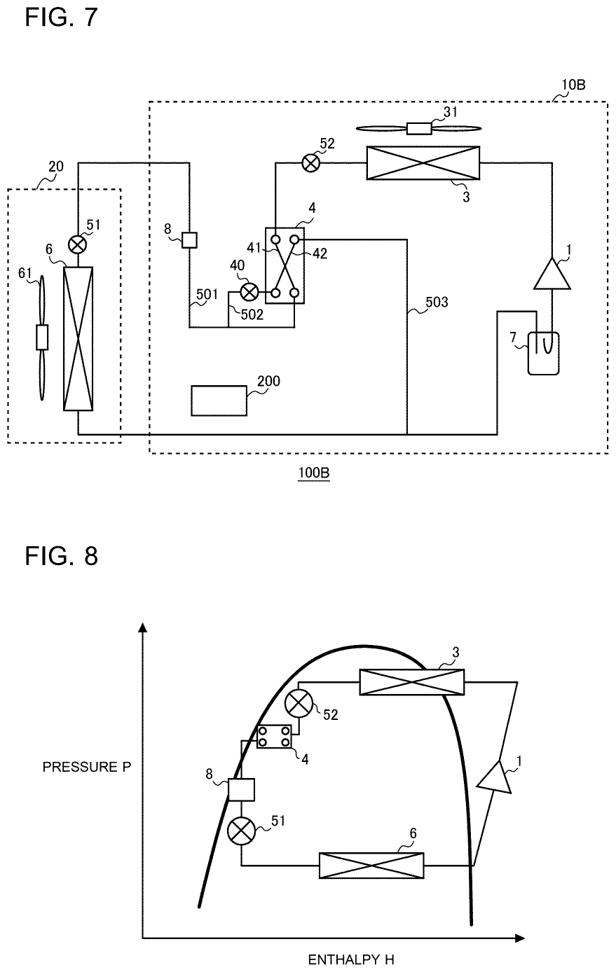

FIG. 7 is a refrigerant circuit diagram of a refrigeration cycle apparatus 100B according to Embodiment 3. As shown in FIG. 7, the refrigeration cycle apparatus 100B of Embodiment 3 differs from the refrigeration cycle apparatus 100 of Embodiment 1 in that a heat-source unit 10B includes a second expansion device 52. Other configurations are the same as those of Embodiment 1.

The second expansion device 52 is arranged between the condenser 3 and the refrigerant-refrigerant heat exchanger 4, and is configured to expand the refrigerant flowing out of the condenser 3 to reduce the pressure of the refrigerant. The second expansion device 52 is, for example, an electronic expansion valve whose opening degree can be controlled. Note that, the second expansion device 52 is not limited to an electronic expansion valve, and may be a mechanical expansion valve in which a pressure receiving part uses a diaphragm, or may be a capillary tube or a similar device.

The opening degree of the second expansion device 52 is controlled by the operation control unit 202 of the controller 200. By controlling the opening degree of the second expansion device 52, the pressure of the working fluid flowing in the refrigerant pipe 501 provided with the optical sensor 8 can be controlled.

The light absorbance characteristics depend on the pressure and the temperature of the working fluid, and the pressure of the working fluid is changed according to the operation of the refrigeration cycle apparatus 100B. For this reason, the operation control unit 202 is configured to control the opening degree of the second expansion device 52 in accordance with the operation of the refrigeration cycle apparatus 100B. In this case, a pressure sensor (not shown) configured to measure the pressure of the working fluid flowing in the refrigerant pipe 501 is provided on the refrigerant pipe 501, and the operation control unit 202 is configured to control the opening degree of the second expansion device 52 so that a measured value of the pressure sensor falls within an allowable range. The allowable range is set to such a range that detection failure of the optical sensor 8 does not occur.

For example, when the opening degree of the second expansion device 52 is reduced, the refrigerant flowing in the refrigerant pipe 501 provided with the optical sensor 8 may enter a two-phase gas-liquid state due to pressure loss by the second expansion device 52. FIG. 8 is a Mollier diagram for a case where the refrigerant flowing in the refrigerant pipe 501 enters a two-phase gas-liquid state due to pressure loss by the second expansion device 52. In this case, as in the conventional example shown in FIG. 5, a gas-liquid interface V is formed in the refrigerant pipe 501, the accuracy in detecting the transmitted light by the optical sensor 8 is reduced, and thus detection failure occurs.

To overcome this problem, the component concentration measuring unit 201 of the controller 200 is configured to, when a detection failure of the optical sensor 8 occurs, notify the operation control unit 202 of the occurrence of detection failure. The operation control unit 202 is configured to, when the occurrence of detection failure of the optical sensor 8 is notified, reduce the opening degree of the first expansion device 51 and increase the opening degree of the second expansion device 52.

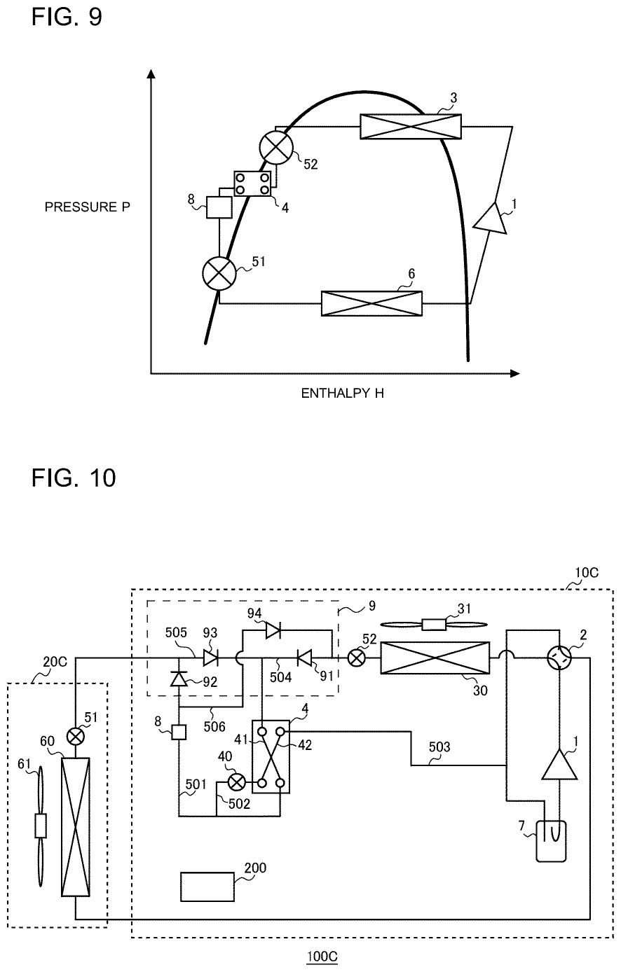

FIG. 9 is a Mollier diagram for the refrigeration cycle apparatus 100B according to Embodiment 3. By controlling the opening degrees of the first expansion device 51 and the second expansion device 52 as described above, the temperature difference between the high-temperature refrigerant and the low-temperature refrigerant in the refrigerant-refrigerant heat exchanger 4 can be increased to promote cooling of the high-temperature refrigerant. As a result, the refrigerant flowing in the refrigerant pipe 501 can be kept in a liquid state, as shown in the Mollier diagram of FIG. 9.

With this configuration, the working fluid flowing in the refrigerant pipe 501 provided with the optical sensor 8 is certainly kept in a liquid state, and thus no gas-liquid interface V is formed in the refrigerant pipe 501. As a result, the accuracy in detecting the transmitted light of the working fluid by the optical sensor 8 is improved and thus the accuracy in measuring the component concentration of the working fluid is also improved.

### Embodiment 4

### <Configuration of Refrigeration Cycle Apparatus>

FIG. 10 is a refrigerant circuit diagram of a refrigeration cycle apparatus 100C according to Embodiment 4. The refrigeration cycle apparatus 100C of Embodiment 3 is an air-conditioning apparatus configured to perform cooling and heating of a space to be air-conditioned.

As shown in FIG. 10, the refrigeration cycle apparatus 100C includes a heat-source unit 10C and a load unit 20C. The heat-source unit 10C is an outdoor unit of the air-conditioning apparatus, and the load unit 20C is an indoor unit of the air-conditioning apparatus. The heat-source unit 10C includes the compressor 1, a flow switching valve 2, an outdoor heat exchanger 30, the first fan 31, the second expansion device 52, a flow switching mechanism 9, the refrigerant-refrigerant heat exchanger 4, the expansion device 40 for cooling, the optical sensor 8, the refrigerant tank 7, and the controller 200. The load unit 20C includes the first expansion device 51, an indoor heat exchanger 60, and the second fan 61.

The configurations and functions of the compressor 1, the first fan 31, the refrigerant-refrigerant heat exchanger 4, the expansion device 40 for cooling, the optical sensor 8, the refrigerant tank 7, and the controller 200 of the heat-source unit 10C are the same as those of Embodiment 1. In addition, the configurations and functions of the first expansion device 51 and the second fan 61 of the load unit 20C are the same as those of Embodiment 1.

The flow switching valve 2 is, for example, a four-way valve and is configured to switch flow passages of the refrigerant discharged from the compressor 1. The controller 200 is configured to change the state of the flow switching valve 2 to perform a heating operation or a cooling operation. More specifically, the flow switching valve 2 is configured to, in the cooling operation, change the flow of the refrigerant by connecting a discharge port of the compressor 1 to a refrigerant inlet of the outdoor heat exchanger 30 and connecting a suction port of the compressor 1 to a refrigerant outlet of the indoor heat exchanger 60. In addition, the flow switching valve 2 is configured to, in the heating operation, change the flow of the refrigerant by connecting the discharge port of the compressor 1 to a refrigerant inlet of the indoor heat exchanger 60 and connecting the suction port of the compressor 1 to a refrigerant output of the outdoor heat exchanger 30.

The outdoor heat exchanger 30 is configured to function as an evaporator in the heating operation and exchange heat between the refrigerant flowing therein and outside air to evaporate and gasify the refrigerant. The outdoor heat exchanger 30 is configured to function as a condenser in the cooling operation and exchange heat between the refrigerant flowing therein and outside air to condense and liquefy the refrigerant. To enhance efficiency of the heat exchange between the refrigerant and air in the outdoor heat exchanger 30, the first fan 31 is arranged adjacent to the outdoor heat exchanger 30.

The indoor heat exchanger 60 is configured to function as a condenser in the heating operation and exchange heat between the refrigerant flowing therein and indoor air to condense and liquefy the refrigerant. The indoor heat exchanger 60 is configured to function as an evaporator in the cooling operation and exchange heat between the refrigerant flowing therein and air to evaporate and gasify the refrigerant. To enhance efficiency of the heat exchange between the refrigerant and air in the indoor heat exchanger 60, the second fan 61 is arranged adjacent to the indoor heat exchanger 60.

Each of the outdoor heat exchanger 30 and the indoor heat exchanger 60 is, for example, a fin-and-tube type heat exchanger or a microchannel heat exchanger. Note that, each of the outdoor heat exchanger 30 and the indoor heat exchanger 60 may be a heat exchanger that exchanges heat between a heat medium, such as water or brine, and the refrigerant. Examples of such a heat exchanger include a shell-and-tube type heat exchanger, a heat pipe type heat exchanger, a double-pipe type heat exchanger, and a plate type heat exchanger.

The second expansion device 52 is configured to expand the refrigerant flowed out of the outdoor heat exchanger 30 to reduce the pressure of the refrigerant. The second expansion device 52 is, for example, an electronic expansion valve whose opening degree can be controlled. Note that, the second expansion device 52 is not limited to an electronic expansion valve, and may be a mechanical expansion valve in which a pressure receiving part uses a diaphragm, or may be a capillary tube or a similar device. The opening degree of the second expansion device 52 is controlled by the operation control unit 202 of the controller 200.

The flow switching mechanism 9 is configured to change the flow of the refrigerant so that the refrigerant-refrigerant heat exchanger 4 is always positioned between the heat exchanger functioning as a condenser and the optical sensor 8 in a case where the refrigeration cycle apparatus 100C performs the cooling operation and in a case where the refrigeration cycle apparatus 100C performs the heating operation. The flow switching mechanism 9 of Embodiment 4 is made up of a first check valve 91, a second check valve 92, a third check valve 93, and a fourth check valve 94.

The first check valve 91 is provided on a refrigerant pipe 504 connecting between the outdoor heat exchanger 30 and the refrigerant inlet of the condensed fluid passage 41 of the refrigerant-refrigerant heat exchanger 4. The first check valve 91 is configured to allow the refrigerant to flow from the outdoor heat exchanger 30 to the condensed fluid passage 41 of the refrigerant-refrigerant heat exchanger 4, and block the refrigerant flow from the condensed fluid passage 41 of the refrigerant-refrigerant heat exchanger 4 to the outdoor heat exchanger 30.

The second check valve 92 is provided between the optical sensor 8 and the first expansion device 51 on the refrigerant pipe 501. The second check valve 92 is configured to allow the refrigerant to flow from optical sensor 8 to the first expansion device 51, and block the refrigerant flow from the first expansion device 51 to the optical sensor 8.

The third check valve 93 is provided on a refrigerant pipe 505 connecting between the first expansion device 51 and the refrigerant inlet of the condensed fluid passage 41 of the refrigerant-refrigerant heat exchanger 4. The third check valve 93 is configured to allow the refrigerant to flow from the first expansion device 51 to the condensed fluid passage 41 of the refrigerant-refrigerant heat exchanger 4, and block the refrigerant flow from the condensed fluid passage 41 of the refrigerant-refrigerant heat exchanger 4 to the first expansion device 51.

The fourth check valve 94 is provided on a branch pipe 506 that is branched from the refrigerant pipe 501 between the optical sensor 8 and the second check valve 92 and is connected to the refrigerant pipe 504 between the outdoor heat exchanger 30 and the first check valve 91. The fourth check valve 94 is configured to allow the refrigerant to flow from the optical sensor 8 to the outdoor heat exchanger 30, and block the refrigerant flow from the outdoor heat exchanger 30 to the optical sensor 8.

### <Operation of Refrigeration Cycle Apparatus>

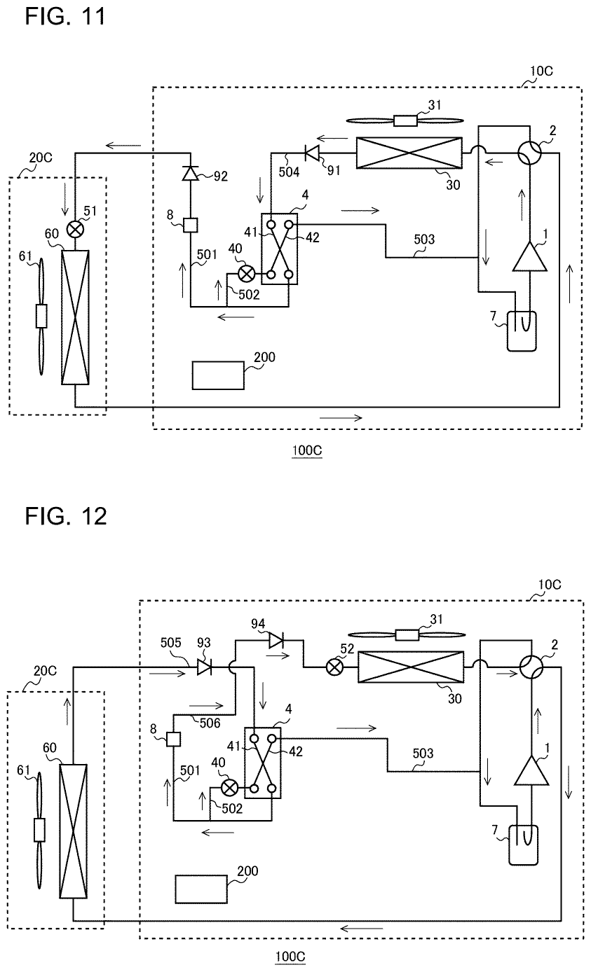

Next, the operation of the refrigeration cycle apparatus 100C will be described along with the flow of the refrigerant. FIG. 11 is an explanatory diagram about flows of the refrigerant in a cooling operation of the refrigeration cycle apparatus 100C according to Embodiment 4. In FIG. 11, a part of the flow passages in the refrigerant circuit diagram of FIG. 10 is omitted for easy reference. The solid lines in FIG. 11 indicate the flow of the refrigerant. In addition, the controller 200 is configured to fully open the second expansion device 52 in the cooling operation. For this reason, illustration of the second expansion device 52 is omitted in FIG. 11.

When the compressor 1 of the refrigeration cycle apparatus 100 is driven, the refrigerant in a high-temperature, high-pressure gas state is discharged from the compressor 1. The refrigerant in a high-temperature, high-pressure gas state discharged from the compressor 1 flows into the outdoor heat exchanger 30 via the flow switching valve 2. In the outdoor heat exchanger 30 functioning as a condenser, heat is exchanged between the refrigerant in a high-temperature, high-pressure gas state flowed therein and the air supplied by the first fan 31. The refrigerant that has undergone heat exchange in the outdoor heat exchanger 30 is condensed, and enters a high-pressure liquid state or two-phase gas-liquid state.

The refrigerant in a high-temperature, high-pressure liquid state or two-phase gas-liquid state flowed out of the outdoor heat exchanger 30 flows into the condensed fluid passage 41 of the refrigerant-refrigerant heat exchanger 4 via the first check valve 91. The refrigerant flowing in the condensed fluid passage 41 of the refrigerant-refrigerant heat exchanger 4 exchanges heat with the refrigerant flowing in the low-pressure passage 42 of the refrigerant-refrigerant heat exchanger 4, and is thus cooled and enters a liquid state. The refrigerant in a liquid state flows out of the condensed fluid passage 41 of the refrigerant-refrigerant heat exchanger 4.

The refrigerant in a liquid state flowed out of the condensed fluid passage 41 of the refrigerant-refrigerant heat exchanger 4 flows in the refrigerant pipe 501, and part of the refrigerant is routed to the branch pipe 502. The refrigerant in a liquid state flowing in the refrigerant pipe 501 passes through the optical sensor 8. The refrigerant in a liquid state flowed through the optical sensor 8 passes through the second check valve 92, is decompressed by the first expansion device 51, enters a low-pressure, two-phase gas-liquid state, and then flows into the indoor heat exchanger 60.

In the indoor heat exchanger 60 functioning as an evaporator, heat is exchanged between the refrigerant in a two-phase gas-liquid state flowed into the indoor heat exchanger 60 and the air supplied by the second fan 61, and the refrigerant in a liquid state, out of the refrigerant in a two-phase gas-liquid state, is evaporated and the refrigerant in a two-phase gas-liquid state enters a low-pressure gas state. The air cooled by this heat exchange process is supplied to the space to be air-conditioned, and thus the space is cooled.

Meanwhile, the refrigerant divided to flow in the branch pipe 502 is decompressed by the expansion device 40 for cooling, enters a medium-pressure liquid state or two-phase gas-liquid state having mainly a liquid form, and flows into the low-pressure passage 42 of the refrigerant-refrigerant heat exchanger 4. The refrigerant flowing in the low-pressure passage 42 of the refrigerant-refrigerant heat exchanger 4 exchanges heat with the refrigerant flowing in the condensed fluid passage 41, enters a two-phase gas-liquid state or a low-pressure gas state, and flows out of the low-pressure passage 42 of the refrigerant-refrigerant heat exchanger 4. The refrigerant in a low-pressure, two-phase gas-liquid state or gas state flowed out of the low-pressure passage 42 of the refrigerant-refrigerant heat exchanger 4 flows in the refrigerant pipe 503, and merges with the refrigerant in a low-pressure gas state flowed out of the indoor heat exchanger 60.

The refrigerant in a low-pressure gas state flowed out of the indoor heat exchanger 60 merges with the refrigerant flowing out of the low-pressure passage 42 of the refrigerant-refrigerant heat exchanger 4 and then flows into the refrigerant tank 7. Then, the refrigerant in a gas state separated in the refrigerant tank 7 is sucked into the compressor 1, compressed again in the compressor 1, and discharged from the compressor 1.

FIG. 12 is an explanatory diagram about flows of the refrigerant in a heating operation of the refrigeration cycle apparatus 100C according to Embodiment 4. In FIG. 12, a part of the flow passages in the refrigerant circuit diagram of FIG. 10 is omitted for easy reference. The solid lines in FIG. 12 indicate the flow of the refrigerant. In addition, the controller 200 is configured to fully open the first expansion device 51 in the heating operation. For this reason, illustration of the first expansion device 51 is omitted in FIG. 12.

When the compressor 1 of the refrigeration cycle apparatus 100C is driven, the refrigerant in a high-temperature, high-pressure gas state is discharged from the compressor 1. The refrigerant in a high-temperature, high-pressure gas state discharged from the compressor 1 flows into the indoor heat exchanger 60 via the flow switching valve 2. In the indoor heat exchanger 60 functioning as a condenser, heat is exchanged between the refrigerant in a high-temperature, high-pressure gas state flowed therein and the air supplied by the second fan 61. The refrigerant that has undergone heat exchange in the indoor heat exchanger 60 is condensed, and enters a high-pressure liquid state or two-phase gas-liquid state. The air heated by this heat exchange process is supplied to the space to be air-conditioned, and thus the space is heated.

The refrigerant in a high-temperature, high-pressure liquid state or two-phase gas-liquid state flowed out of the indoor heat exchanger 60 flows into the condensed fluid passage 41 of the refrigerant-refrigerant heat exchanger 4 via the refrigerant pipe 505 and the third check valve 93. The refrigerant flowing in the condensed fluid passage 41 of the refrigerant-refrigerant heat exchanger 4 exchanges heat with the refrigerant flowing in the low-pressure passage 42 of the refrigerant-refrigerant heat exchanger 4, and is thus cooled and enters a liquid state. The refrigerant in a liquid state flows out of the condensed fluid passage 41 of the refrigerant-refrigerant heat exchanger 4.

The refrigerant in a liquid state flowed out of the condensed fluid passage 41 of the refrigerant-refrigerant heat exchanger 4 flows in the refrigerant pipe 501, and part of the refrigerant is routed to the branch pipe 502. The refrigerant in a liquid state flowing in the refrigerant pipe 501 passes through the optical sensor 8. The refrigerant in a liquid state flowed through the optical sensor 8 passes through the branch pipe 506 and the fourth check valve 94, is decompressed by the second expansion device 52, enters a low-pressure, two-phase gas-liquid state, and then flows into the outdoor heat exchanger 30.

In the outdoor heat exchanger 30 functioning as an evaporator, heat is exchanged between the refrigerant in a two-phase gas-liquid state flowed into the outdoor heat exchanger 30 and the air supplied by the first fan 31, and the refrigerant in a liquid state, out of the refrigerant in a two-phase gas-liquid state, is evaporated and the refrigerant in a two-phase gas-liquid state enters a low-pressure gas state.

Meanwhile, the refrigerant divided to flow in the branch pipe 502 is decompressed by the expansion device 40 for cooling, enters a medium-pressure liquid state or two-phase gas-liquid state having mainly a liquid form, and flows into the low-pressure passage 42 of the refrigerant-refrigerant heat exchanger 4. The refrigerant flowing in the low-pressure passage 42 of the refrigerant-refrigerant heat exchanger 4 exchanges heat with the refrigerant flowing in the condensed fluid passage 41, enters a two-phase gas-liquid state or a low-pressure gas state, and flows out of the low-pressure passage 42 of the refrigerant-refrigerant heat exchanger 4. The refrigerant in a low-pressure, two-phase gas-liquid state or gas state flowed out of the low-pressure passage 42 of the refrigerant-refrigerant heat exchanger 4 flows in the refrigerant pipe 503, and merges with the refrigerant in a low-pressure gas state flowed out of the outdoor heat exchanger 30.

The refrigerant in a low-pressure gas state flowed out of the outdoor heat exchanger 30 merges with the refrigerant flowing out of the low-pressure passage 42 of the refrigerant-refrigerant heat exchanger 4 and then flows into the refrigerant tank 7. Then, the refrigerant in a gas state separated in the refrigerant tank 7 is sucked into the compressor 1, compressed again in the compressor 1, and discharged from the compressor 1.

As described above, also in the refrigeration cycle apparatus 100C of Embodiment 4, the refrigerant-refrigerant heat exchanger 4 is always positioned between the heat exchanger functioning as a condenser and the optical sensor 8 in both cases of the cooling operation and the heating operation. Thus, as with the case of Embodiment 1, the accuracy in measuring the component concentration of the working fluid can be improved in the refrigeration cycle apparatus 100C.

Note that, the flow switching mechanism 9 is not limited to the configuration having four check valves. The flow switching mechanism 9 may be formed as a mechanism that switches flow passages of the refrigerant so that the optical sensor 8 is always positioned downstream of the condensed fluid passage 41 of the refrigerant-refrigerant heat exchanger 4 in the cooling operation and in the heating operation, and may be formed as a four-way valve, for example.

### Embodiment 5

### <Configuration of Refrigeration Cycle Apparatus>

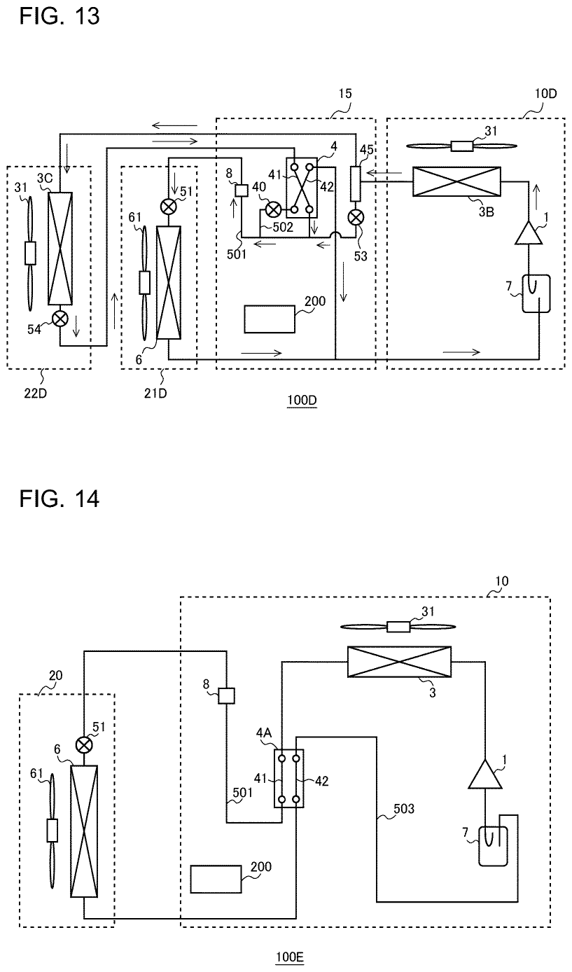

FIG. 13 is a refrigerant circuit diagram of a refrigeration cycle apparatus 100D according to Embodiment 5. The refrigeration cycle apparatus 100D of Embodiment 5 is an air-conditioning apparatus configured to perform cooling and heating in multiple spaces to be air-conditioned.

As shown in FIG. 13, the refrigeration cycle apparatus 100D of Embodiment 5 includes the heat-source unit 10D, a relay unit 15, and multiple load units 21D and 22D. The heat-source unit 10D, the relay unit 15, and the multiple load units 21D and 22D have respective casings, and are installed at different places, such as outdoors and indoors.

The heat-source unit 10D includes the compressor 1, a first condenser 3B, the first fan 31, and the refrigerant tank 7. The relay unit 15 includes the refrigerant-refrigerant heat exchanger 4, the expansion device 40 for cooling, the optical sensor 8, the controller 200, a branch unit 45, and a third expansion device 53. The load unit 21D includes the first expansion device 51, the evaporator 6, and the second fan 61. The load unit 22D includes a second condenser 3C, a fourth expansion device 54, and the first fan 31.

The configurations and functions of the compressor 1, the refrigerant-refrigerant heat exchanger 4, the expansion device 40 for cooling, the first expansion device 51, the evaporator 6, the second fan 61, the refrigerant tank 7, the optical sensor 8, and the controller 200 of the refrigeration cycle apparatus 100D are the same as those of Embodiment 1. The configurations and functions of the first condenser 3B and the second condenser 3C are the same as those of the condenser 3 of Embodiment 1.

The branch unit 45 is configured to divide the refrigerant flowed therein to flow into the load unit 21D and the load unit 22D. The branch unit 45 is, for example, a gas-liquid separator, and is connected to the load unit 21D and the load unit 22D so that the refrigerant that contains much refrigerant in a gas phase is allowed to flow into the second condenser 3C of the load unit 22D and the refrigerant that contains much refrigerant in a liquid phase is allowed to flow into the evaporator 6 of the load unit 21D.

The third expansion device 53 is configured to expand the refrigerant flowed out of the branch unit 45 to reduce the pressure of the refrigerant. The fourth expansion device 54 is configured to expand the refrigerant flowed out of the second condenser 3C to reduce the pressure of the refrigerant. The third expansion device 53 and the fourth expansion device 54 are, for example, electronic expansion valves whose opening degrees can be controlled. Note that, each of the third expansion device 53 and the fourth expansion device 54 is not limited to an electronic expansion valve, and may be a mechanical expansion valve in which a pressure receiving part uses a diaphragm, or may be a capillary tube or a similar device. The opening degrees of the third expansion device 53 and the fourth expansion device 54 are controlled by the operation control unit 202 of the controller 200.

### <Operation of Refrigeration Cycle Apparatus>

Next, the operation of the refrigeration cycle apparatus 100D will be described along with the flow of the refrigerant. The solid lines in FIG. 13 indicate the flow of the refrigerant. When the compressor 1 of the refrigeration cycle apparatus 100D is driven, the refrigerant in a high-temperature, high-pressure gas state is discharged from the compressor 1. The refrigerant in a high-temperature, high-pressure gas state discharged from the compressor 1 flows into the first condenser 3B.

In the first condenser 3B, heat is exchanged between the refrigerant in a high-temperature, high-pressure gas state flowed into the first condenser 3B and the air supplied by the first fan 31. The refrigerant that has undergone heat exchange in the first condenser 3B is condensed, and enters a high-temperature, high-pressure two-phase gas-liquid state.

The refrigerant in a high-temperature, high-pressure two-phase gas-liquid state flowed out of the first condenser 3B flows into the branch unit 45. The refrigerant in a two-phase gas-liquid state flowed into the branch unit 45 is separated into the refrigerant in a gas state and the refrigerant in a liquid state. The refrigerant in a gas state flows into the second condenser 3C. In the second condenser 3C, heat is exchanged between the refrigerant in a high-temperature, high-pressure gas state flowed into the second condenser 3C and the air supplied by the first fan 31. The refrigerant that has undergone heat exchange in the second condenser 3C is condensed, and enters a high-temperature, high-pressure liquid state. The air heated by this heat exchange process is supplied to the space to be air-conditioned in which the load unit 22D is provided, and thus the space is heated.

The refrigerant in a high-temperature, high-pressure liquid state flowed out of the second condenser 3C is decompressed by the fourth expansion device 54, and then flows into the condensed fluid passage 41 of the refrigerant-refrigerant heat exchanger 4. The refrigerant flowing in the condensed fluid passage 41 of the refrigerant-refrigerant heat exchanger 4 exchanges heat with the refrigerant flowing in the low-pressure passage 42 of the refrigerant-refrigerant heat exchanger 4, and is thus cooled and enters a liquid state. The refrigerant in a liquid state flows out of the condensed fluid passage 41 of the refrigerant-refrigerant heat exchanger 4.

The refrigerant in a liquid state flowed out of the condensed fluid passage 41 of the refrigerant-refrigerant heat exchanger 4 merges with the refrigerant in a liquid state flowed out from the branch unit 45, the pressure of which is reduced by the third expansion device 53. Then, the refrigerant flows in the refrigerant pipe 501, and part of the refrigerant is routed to the branch pipe 502. The refrigerant in a liquid state flowing in the refrigerant pipe 501 passes through the optical sensor 8. The refrigerant in a liquid state flowed through the optical sensor 8 is decompressed by the first expansion device 51, enters a low-pressure, two-phase gas-liquid state, and then flows into the evaporator 6.

In the evaporator 6, heat is exchanged between the refrigerant in a two-phase gas-liquid state flowed into the evaporator 6 and the air supplied by the second fan 61, and the refrigerant in a liquid state, out of the refrigerant in a two-phase gas-liquid state, is evaporated and the refrigerant in a two-phase gas-liquid state enters a low-pressure gas state. The air cooled by this heat exchange process is supplied to the space to be air-conditioned in which the load unit 21D is provided, and thus the space is cooled.

Meanwhile, the refrigerant divided to flow in the branch pipe 502 is decompressed by the expansion device 40 for cooling, enters a medium-pressure liquid state or two-phase gas-liquid state having mainly a liquid form, and flows into the low-pressure passage 42 of the refrigerant-refrigerant heat exchanger 4. The refrigerant flowing in the low-pressure passage 42 of the refrigerant-refrigerant heat exchanger 4 exchanges heat with the refrigerant flowing in the condensed fluid passage 41, enters a two-phase gas-liquid state or a low-pressure gas state, and flows out of the low-pressure passage 42 of the refrigerant-refrigerant heat exchanger 4. The refrigerant in a low-pressure, two-phase gas-liquid state or gas state flowed out of the low-pressure passage 42 of the refrigerant-refrigerant heat exchanger 4 flows in the refrigerant pipe 503, and merges with the refrigerant in a low-pressure gas state flowed out of the evaporator 6.

The refrigerant in a low-pressure gas state flowed out of the evaporator 6 merges with the refrigerant flowing out of the low-pressure passage 42 of the refrigerant-refrigerant heat exchanger 4 and then flows into the refrigerant tank 7. Then, the refrigerant in a gas state separated in the refrigerant tank 7 is sucked into the compressor 1, compressed again in the compressor 1, and discharged from the compressor 1. This cycle is repeated in the refrigeration cycle apparatus 100.

Even when the optical sensor 8 is provided at the relay unit 15 as the case of the refrigeration cycle apparatus 100D of Embodiment 5, the accuracy in detecting the component concentration of the working fluid in the refrigeration cycle apparatus 100D can be improved, as with the case of Embodiment 1. That is, the optical sensor 8 only needs to be installed at a place between the refrigerant outlet of the condensed fluid passage 41 of the refrigerant-refrigerant heat exchanger 4 and the first expansion device 51, and the unit in which the optical sensor 8 is installed is not limited to any specific unit.

In addition, with the configuration of the refrigeration cycle apparatus 100D, the component concentration of the working fluid flowing in the heat exchanger functioning as an evaporator can be obtained even when the heat exchangers provided in the multiple load units include both a heat exchanger functioning as an evaporator and a heat exchanger functioning as a condenser.

Furthermore, in a case where the refrigeration cycle apparatus 100D includes multiple condensers as the case of Embodiment 5, excess refrigerant is more likely to be generated compared with a case of only one condenser, and thus the degree of superheat at the inlet of the compressor 1 is reduced or the refrigerant enters a two-phase gas-liquid state. In this case also, both quality and performance improvement can be satisfied by installing the optical sensor 8 at a place between a condenser and the first expansion device and measuring the component concentration of the working fluid to control the operation.

Note that, two or more optical sensors 8 and two or more refrigerant-refrigerant heat exchangers 4 may be provided in the refrigeration cycle apparatus 100D. The number of the load units 21D and the number of the load units 22D to be installed in the refrigeration cycle apparatus 100D are not limited to the numbers in the example shown in FIG. 13, and may be more than one.

Although the descriptions of the embodiments are given above, the present disclosure is not limited to the above-mentioned embodiments. Various modifications and combinations are conceivable within the scope of the present disclosure. Modification examples of the present disclosure will be described below.

### Modification Example 1

FIG. 14 is a refrigerant circuit diagram of a refrigeration cycle apparatus 100E according to Modification Example 1. As shown in FIG. 14, the refrigerant inlet of the low-pressure passage 42 of a refrigerant-refrigerant heat exchanger 4A may be connected to the refrigerant outlet of the evaporator 6, and the refrigerant outlet of the low-pressure passage 42 may be connected to the refrigerant tank 7 via the refrigerant pipe 503. In this case, the branch pipe 502 and the expansion device 40 for cooling can be omitted.

With the configuration of Modification Example 1, the refrigerant flowing in the refrigerant pipe 501 provided with the optical sensor 8 can be kept in a liquid state, and similar effects to those of Embodiment 1 can be obtained.

### Modification Example 2

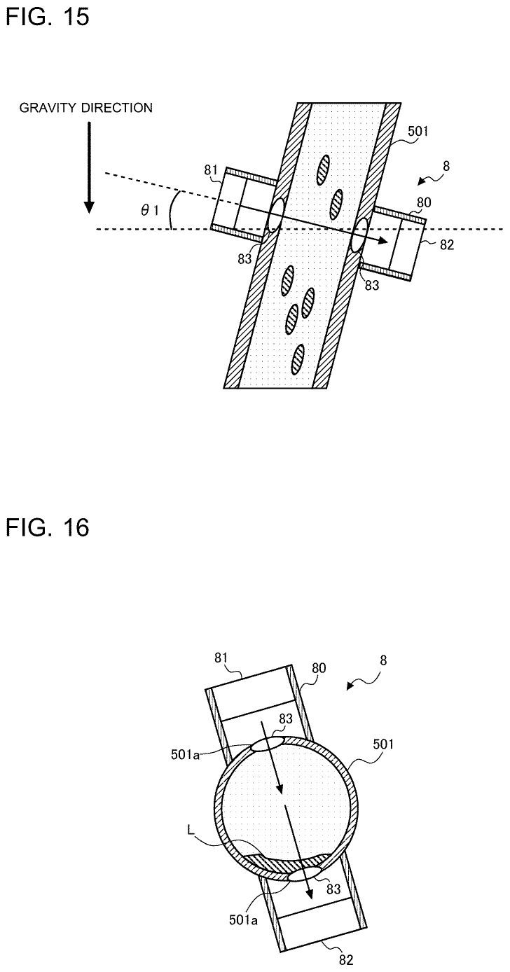

FIG. 15 is a schematic diagram illustrating an installation direction of the optical sensor 8 of the refrigeration cycle apparatus according to Modification Example 2. As shown in FIG. 15, the optical sensor 8 of Modification Example 2 is installed on the refrigerant pipe 501 in such a manner that an acute angle θ1 between the direction of light emitted from the irradiator 81 and a plane perpendicular to the gravity direction is smaller than 45 degrees. More preferably, the optical sensor 8 is installed on the refrigerant pipe 501 in such a manner that the acute angle θ1 between the direction of light emitted from the irradiator 81 and the plane perpendicular to the gravity direction is smaller than 30 degrees.

When the acute angle θ1 between the direction of light emitted from the irradiator 81 of the optical sensor 8 and the plane perpendicular to the gravity direction is greater than 45 degrees and the direction of irradiated light becomes close to the gravity direction, an interface of the working fluid is formed due to the difference in density in the irradiation direction. FIG. 16 is an explanatory diagram about a state of the working fluid at a low flow velocity. When the flow velocity of the working fluid flowing in the refrigerant pipe 501 is low, the difference in density is generated between the components in the working fluid flowing in the refrigerant pipe 501 and thus a liquid-liquid interface L is formed, as shown in FIG. 16. When the working fluid is biased as shown in FIG. 16, deviation occurs between the composition ratio of the composition and the volume ratio of the fluid in the light detection. In the case of FIG. 16, the volume of a component having a heavy weight in the working fluid is detected larger than the actual volume. Meanwhile, when the optical sensor 8 is arranged as shown in Modification Example 2, lowering of the accuracy in detecting the transmitted light by the separation due to the density difference is prevented, and the accuracy in measuring the component concentration of the working fluid is improved. Note that, although FIG. 15 shows a case where the acute angle between the extending direction of the refrigerant pipe 501 and the gravity direction is smaller than 45 degrees, the acute angle between the extending direction of the refrigerant pipe 501 and the gravity direction may be larger than 45 degrees.

### Modification Example 3

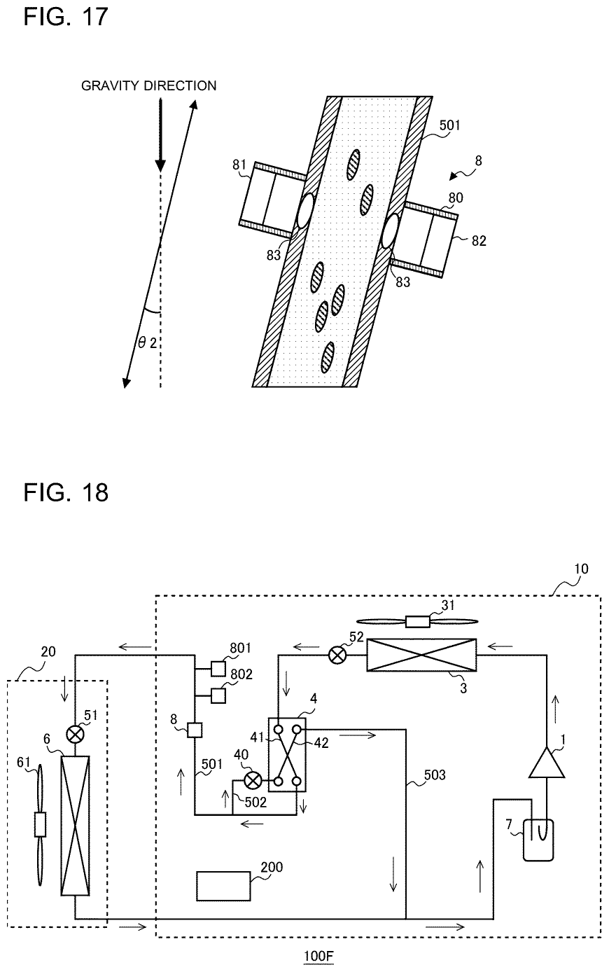

FIG. 17 is a schematic diagram illustrating an installation direction of the optical sensor 8 of the refrigeration cycle apparatus according to Modification Example 3. As shown in FIG. 17, the refrigerant pipe 501, on which the optical sensor 8 of Modification Example 3 is provided, is arranged in such a manner that an acute angle θ2 between the extending direction of the refrigerant pipe 501 and the gravity direction is smaller than 45 degrees. More preferably, the refrigerant pipe 501, on which the optical sensor 8 is provided, is arranged in such a manner that the acute angle θ2 between the extending direction of the refrigerant pipe 501 and the gravity direction is smaller than 30 degrees.

With the configuration of Modification Example 3, because the angle between the flow direction of the refrigerant in the refrigerant pipe 501 and the gravity direction is reduced, a gravity-directional component of the flow of the refrigerant is increased. Thus, the separation due to the density difference in the refrigerant is prevented, and the symmetry of component distribution in the cross-sectional direction of the flow passage can be secured. As a result, lowering of the accuracy in detecting the transmitted light is prevented, and the accuracy in measuring the component concentration of the working fluid is improved. Especially even in a case of low flow velocity of the refrigerant, the detection accuracy of the transmitted light and the accuracy in obtaining component concentration are improved.

### Modification Example 4

FIG. 18 is a refrigerant circuit diagram of a refrigeration cycle apparatus 100F according to Modification Example 4. It is known from experiments that the absorbance measured by the optical sensor 8 is highly sensitive to the temperature and the pressure of the working fluid. Thus, as shown in FIG. 18, a temperature sensor 801 and a pressure sensor 802 may be provided on the refrigerant pipe 501 of the refrigeration cycle apparatus 100F to measure the temperature and the pressure of the working fluid flowing in the refrigerant pipe 501. Then, the component concentration may be corrected by the component concentration measuring unit 201 of the controller 200 by using the measured temperature and pressure and a table that contains a predetermined correction value. By arranging the temperature sensor 801 and the pressure sensor 802 in the same unit as the optical sensor 8, the effect of a pressure loss in the refrigerant-refrigerant heat exchanger 4 or a pressure loss in the refrigerant pipe 501 between units can be eliminated.

In addition, when a zeotropic refrigerant mixture is used as the working fluid of the refrigeration cycle apparatus 100, the ratio of circulating composition in the working fluid changes significantly depending on leakage of the refrigerant at the time when the refrigerant is filled at installation or the amount of the refrigerant held in the refrigerant tank 7, which changes according to operation. To achieve an appropriate control of the refrigeration cycle apparatus 100, the composition ratio of the working fluid may be predicted to control the frequency of the compressor 1 or the opening degree of the first expansion device 51. In this case, a learning model, which has been obtained in advance by learning based on the absorbance of a component included in the working fluid, temperature, and pressure, is stored in the storage unit 203 of the controller 200. Then, the controller 200 may output the circulating composition ratio of the working fluid by using the learning model with, as inputs, the absorbance, the refrigerant temperature, and the refrigerant pressure measured by the optical sensor 8, the temperature sensor 801, and the pressure sensor 802.

In this case, the controller 200 is configured to, when the refrigerant pressure measured by the pressure sensor 802 is higher than a learning range of the learning model and the accuracy in measuring the component concentration is reduced, reduce the opening degree of the second expansion device 52. In addition, the controller 200 is configured to, when the refrigerant pressure measured by the pressure sensor 802 is lower than a learning range of the learning model and the accuracy in measuring the component concentration is reduced, increase the opening degree of the second expansion device 52. Thus, the accuracy in measuring the component concentration is improved. A threshold to be used in the determination of changing the opening degree of the second expansion device 52 is a design value set by a pressure range of the learning model.

### Modification Example 5

FIG. 19 is a refrigerant circuit diagram of a refrigeration cycle apparatus 100G according to Modification Example 5. The refrigeration cycle apparatus 100G of Modification Example 5 includes a heat-source unit 10G, a load unit 21G, and a load unit 22G. The heat-source unit 10G includes the compressor 1, the flow switching valve 2, the outdoor heat exchanger 30, the first fan 31, the first expansion device 51, the refrigerant-refrigerant heat exchanger 4, the expansion device 40 for cooling, the optical sensor 8, the refrigerant tank 7, and the controller 200. The load unit 21G and the load unit 22G each include an indoor heat exchanger 60G and the second fan 61.

In case where, like the refrigeration cycle apparatus 100G of Modification Example 5, the cooling operation and the heating operation is switchable and a plurality of load units are provided, and when either of the cooling operation and the heating operation has more heat exchangers functioning as condensers, the optical sensor 8 may be provided between the condensers and the expansion device provided downstream of the condensers.

In the configuration shown in FIG. 19, two indoor heat exchangers 60G function as condensers in the heating operation and one outdoor heat exchanger 30 functions as a condenser in the cooling operation. That is, the number of condensers in the heating operation is larger than that in the cooling operation. Thus, the refrigerant-refrigerant heat exchanger 4 is provided between the indoor heat exchangers 60G functioning as condensers in the heating operation and the first expansion device 51 arranged downstream of and the indoor heat exchangers 60G, and the optical sensor 8 is provided downstream of the refrigerant-refrigerant heat exchanger 4. Note that, there is no trouble in the effects even when another expansion device is provided between the refrigerant-refrigerant heat exchanger 4 and the condensers.

Excess refrigerant is likely to be generated in the operation with more condensers, compared with the operation with fewer condensers, and causes reduction in the degree of superheat at the inlet of the compressor 1 or causes the refrigerant to enter a two-phase gas-liquid state. In the refrigeration cycle apparatus 100G capable of switching the cooling operation and the heating operation, the amount of the refrigerant is determined based on the operation in which more refrigerant is required in general. As shown in FIG. 19, in the apparatus in which one heat-source unit and multiple load units are connected, the required amount of the refrigerant is increased in the cooling operation in which the number of evaporators are increased, because the refrigerant in the connections between the heat-source unit and the load units enters a liquid state. Therefore, the amount of the refrigerant is determined based on the cooling operation. Excess refrigerant is generated in the heating operation in which the number of condensers is increased and is stored in the refrigerant tank 7 and other spaces. At this time, because a large volume of high-boiling components of the refrigerating machine oil or the zeotropic refrigerant mixture is stored in the refrigerant tank 7, the composition of the refrigerating machine oil or the refrigerant mixture in the refrigerant flowing in the circuits other than the refrigerant tank 7 becomes unclear, and a performance degradation or a failure is likely to occur. To solve a significant problem caused in the operation in which the number of condensers is increased as in the case of the example of Modification Example 5, the application of Modification Example 5 can obtain a great effect, ensuring that the working fluid flowing in the refrigerant pipe 501 provided with the optical sensor 8 enters a liquid state (single-phase state) in the operation with more condensers.

### Modification Example 6

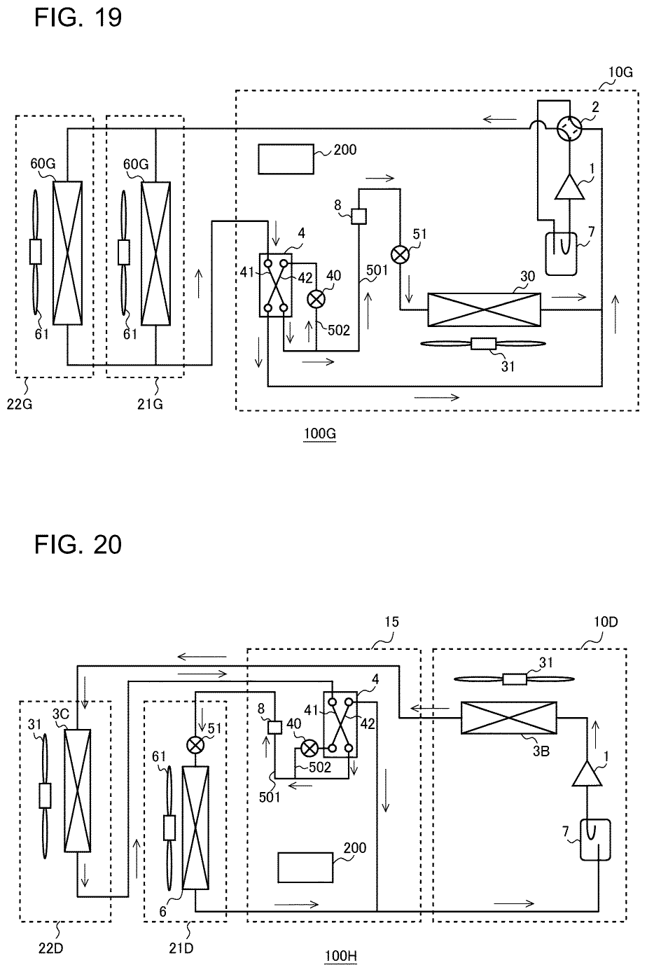

FIG. 20 is a refrigerant circuit diagram of a refrigeration cycle apparatus 100H according to Modification Example 6. Modification Example 6 is a modification of Embodiment 5. As shown in FIG. 20, the refrigeration cycle apparatus 100H has a configuration in which the branch unit 45, the third expansion device 53, the fourth expansion device 54 are omitted from the refrigeration cycle apparatus 100D of Embodiment 5. In this case also, the same effects as Embodiment 5 can be obtained.

As other modifications, although the controller 200 includes the component concentration measuring unit in the abovementioned embodiments, the optical sensor 8 may be provided with a controller and a component concentration measuring unit. In this case, the component concentration of the working fluid is obtained in the optical sensor 8 from the detected transmitted light, and the obtained component concentration is transmitted to the operation control unit 202 of the controller 200.

Furthermore, the embodiments and the modification examples can be combined as desired. For example, the second expansion device 52 of Embodiment 3 may be provided in the configuration of Embodiment 2, Embodiment 5, Modification Example 5, or Modification Example 6. In Embodiment 1, 2, 3, 4, or 5, or Modification Example 5 or 6, the circulating composition ratio of the working fluid may be output by using the learning model of Modification Example 4.

### REFERENCE SIGNS LIST

1: compressor, 2: flow switching valve, 3, 3A: condenser, 3B: first condenser, 3C: second condenser, 4, 4A: refrigerant-refrigerant heat exchanger, 6: evaporator, 7: refrigerant tank, 8: optical sensor, 9: flow switching mechanism, 10, 10A, 10B, 10C, 10D, 10G: heat-source unit, 15: relay unit, 20, 20A, 20C, 21D, 21G, 22D, 22G: load unit, 30: outdoor heat exchanger, 31: first fan, 32: pump, 40: expansion device for cooling, 41: condensed fluid passage, 42: low-pressure passage, 45: branch unit, 51: first expansion device, 52: second expansion device, 53: third expansion device, 54: fourth expansion device, 60, 60G: indoor heat exchanger, 61: second fan, 80: casing, 81: irradiator, 82: detector, 83: window plate, 91: first check valve, 92: second check valve, 93: third check valve, 94: fourth check valve, 100, 100A, 100B, 100C, 100D, 100E, 100F, 100G, 100H: refrigeration cycle apparatus, 200: controller, 201: component concentration measuring unit, 202: operation control unit, 203: storage unit, 300: water circuit, 501, 503, 504, 505: refrigerant pipe, 501a: opening, 502, 506: branch pipe, 801: temperature sensor, 802: pressure sensor

1. A refrigeration cycle apparatus comprising:
a compressor configured to compress and discharge a working fluid;
a condenser configured to condense the working fluid discharged from the compressor;
a refrigerant-refrigerant heat exchanger provided with a condensed fluid passage in which the working fluid flowing out of the condenser flows and a low-pressure passage in which the working fluid having a lower pressure than that of the working fluid flowing in the condensed fluid passage flows, and configured to exchange heat between the working fluid flowing in the condensed fluid passage and the working fluid flowing in the low-pressure passage;
a first expansion device configured to reduce a pressure of the working fluid flowing out of the condensed fluid passage of the refrigerant-refrigerant heat exchanger;
an evaporator configured to evaporate the working fluid, the pressure of which is reduced by the first expansion device;
an optical sensor provided on a pipe connecting between an outlet of the condensed fluid passage of the refrigerant-refrigerant heat exchanger and the first expansion device, and provided with an irradiator configured to irradiate the working fluid flowing in the pipe with light and a detector configured to detect a light transmitting through the working fluid; and
a controller configured to obtain a concentration of a component included in the working fluid based on a detection result of the optical sensor.

2. The refrigeration cycle apparatus of claim 1, wherein
the controller is configured to control an operation frequency of the compressor or an opening degree of the first expansion device based on the concentration of the component included in the working fluid.

3. The refrigeration cycle apparatus of claim 1, wherein
the optical sensor is provided in a same unit in which the refrigerant-refrigerant heat exchanger is provided.

4. The refrigeration cycle apparatus of claim 1, wherein
the working fluid is a zeotropic refrigerant mixture in which at least two kinds of refrigerants having different boiling points are mixed.

5. The refrigeration cycle apparatus of claim 1, wherein
an inlet of the low-pressure passage of the refrigerant-refrigerant heat exchanger is connected to a part of the pipe between the outlet of the condensed fluid passage and the optical sensor, and
an outlet of the low-pressure passage of the refrigerant-refrigerant heat exchanger is connected to an outlet of the evaporator.

6. The refrigeration cycle apparatus of claim 1, wherein
an inlet of the low-pressure passage of the refrigerant-refrigerant heat exchanger is connected to an outlet of the evaporator, and
an outlet of the low-pressure passage of the refrigerant-refrigerant heat exchanger is connected to a suction port of the compressor.

7. The refrigeration cycle apparatus of claim 1, further comprising
a second expansion device provided between the condenser and the refrigerant-refrigerant heat exchanger.

8. The refrigeration cycle apparatus of claim 1, further comprising:
a flow switching valve configured to switch flow passages for the working fluid discharged from the compressor; and
a flow switching mechanism configured to switch flows of the working fluid in such a manner that the refrigerant-refrigerant heat exchanger is positioned between the condenser and the optical sensor in the flow of the working fluid regardless of the switching of flow passages for the working fluid by the flow switching valve.

9. The refrigeration cycle apparatus of claim 1, further comprising:
a flow switching valve configured to switch flow passages for the working fluid discharged from the compressor;
a plurality of indoor heat exchangers each configured to function as the condenser in a heating operation and function as the evaporator in a cooling operation; and
an outdoor heat exchanger configured to function as the evaporator in the heating operation and function as the condenser in the cooling operation,
wherein the optical sensor is provided between the refrigerant-refrigerant heat exchanger and the first expansion device provided downstream of the indoor heat exchangers and outdoor heat exchanger that function as the condensers in one of the cooling operation and the heating operation in which a number of heat exchangers and outdoor heat exchanger function as the condensers is larger than in an other of the cooling operation and the heating operation.

10. The refrigeration cycle apparatus of claim 1, wherein
the optical sensor is attached to the pipe in such a manner that an acute angle between a direction of the irradiating light and a plane perpendicular to a direction of gravity is smaller than 45 degrees.

11. The refrigeration cycle apparatus of claim 1, wherein
the pipe is arranged in such a manner that an acute angle between an extending direction of the pipe and the direction of gravity is smaller than 45 degrees.

12. The refrigeration cycle apparatus of claim 1, further comprising:
a temperature sensor configured to measure a temperature of the working fluid flowing in the pipe; and
a pressure sensor configured to measure a pressure of the working fluid flowing in the pipe.

13. The refrigeration cycle apparatus of claim 12, wherein
the controller includes a storage configured to store a model obtained by learning based on an absorbance of the component included in the working fluid, a temperature, and a pressure of the working fluid, and
the controller is configured to predict a composition of the working fluid by using the model with the absorbance, the temperature, and the pressure measured by the optical sensor, the temperature sensor, and the pressure sensor as inputs.
